(19) United States
(12) Patent Application Publication
(10) Pub. No.: US 2026/0044453 A1
(43) Pub. Date: Feb. 12, 2026

(54) EXECUTABLE CODE CACHE

(71) Applicant: TEXAS INSTRUMENTS INCORPORATED, Dallas, TX (US)

(72) Inventors: Varshashree Kottadamane Manjunatha Swamy, Bangaluru (IN); Narendra Ravilla, Bangalore (IN); Naveen Kothuri, Rajahmundry (IN); Venkatesh Natarajan, Bangalore (IN); Saya Goud Langadi, Sugar Land, TX (US)

(21) Appl. No.: 19/033,007

(22) Filed: Jan. 21, 2025

Related U.S. Application Data
(60) Provisional application No. 63/680,116, filed on Aug. 7, 2024.

(51) Int. Cl. G06F 12/0862; G06F 9/38

(52) U.S. Cl. CPC G06F 12/0862; G06F 9/3814; G06F 2212/6028

(57) ABSTRACT

Systems and methods for implementing a code cache (CC) architecture are provided. For discontinuous requests, the CC forwards the request to memory while also checking the buffer for the data. If in the buffer, the CC serves the data from the buffer and discards the memory response. If not, the CC serves the data upon receipt from memory. For linear requests, the CC looks ahead on the prior request to the next address, checks the buffer, and stores the lookahead result. Upon receiving the linear request, the lookahead result is checked to determine whether the data is in the buffer. If so, the CC serves the request from the buffer. If not, the CC forwards the request to memory. In all cases, logic to determine whether the data is in the buffer does not slow down the response time from the CC.

### CROSS REFERENCE TO RELATED APPLICATION

This application claims the benefit of and priority to U.S. Provisional Patent Application No. 63/680,116 , titled “TIMING-OPTIMIZED CODE CACHE MECHANISM,” filed Aug. 7, 2024, which is hereby incorporated by reference in its entirety for all purposes.

### TECHNICAL FIELD

Aspects of the disclosure are related to the field of computing hardware and software and more particularly to techniques for optimizing microcontroller data retrieval from memory.

### BACKGROUND

Microcontrollers commonly utilize memory, including non-volatile memory (e.g., flash memory) to store executable code (e.g., instructions) and other forms of data (e.g., values for use by the code, trim information for configuring hardware, etc.). Access time for retrieving data from memory may be high, creating significant latency penalties when executing code or reading data from memory. This may become a bottleneck when code is executed from memory. Architectural controls, such as a code cache in a memory read interface architecture, may help reduce latency and come closer to achieving the ideal 0-Wait State (WS) code execution.

Timing checks for an integrated circuit may include a set of clock-based checks such as intracycle checks to determine whether data paths between latches can complete within a given clock cycle, intercycle checks to determine whether data paths with latches can complete within a given number of clock cycles, and checks to determine whether data paths between clock domains can complete based on a function of the respective clocks). Timing closure often proves challenging and complex in any system on a chip (SoC), so the code cache architecture should ensure that the timing closure complexity is not aggravated. However, existing systems including a code cache often aggravate timing closure issues. Accordingly, improvements are needed.

### SUMMARY

Disclosed herein is technology, including systems, methods, and devices for data retrieval in an architecture including a code cache.

One general aspect includes a system having an initiator (e.g., a central processing unit) configured to provide a request for data stored in a memory. The system may also have a memory read interface coupled to the initiator, which may include code cache circuitry. The code cache circuitry includes a buffer and buffer check circuitry configured to determine whether the data associated with the request is stored in the buffer based on a memory address associated with the request. The code cache circuitry may further include access circuitry configured to, concurrent with the buffer check circuitry determining whether the data is stored in the buffer, request the data from the memory. The memory read interface is configured to, in response to the buffer check circuitry determining that the data is stored in the buffer, provide the data from the buffer and discard the copy of the data returned from the memory. The memory read interface is further configured to, in response to the buffer check circuitry determining the data is not stored in the buffer, provide the data from the memory once the data is returned and store the data in the buffer.

Implementations may include one or more of the following features. In some embodiments, the data is a first set of data and the cache circuitry may further include a lookahead memory and lookahead circuitry. The lookahead circuitry may be configured to identify the next memory address based on the memory address associated with the request, use the buffer check circuitry to determine whether a second set of data stored at the next memory address is stored in the buffer, and store the result of the lookahead determination in the lookahead memory. In some embodiments, the cache circuitry may further include linear access circuitry configured to, in response to a linear access request, based on the result in the lookahead memory indicating the second set of data is stored in the buffer, provide the second set of data to the initiator from the buffer. The linear access circuitry may be further configured to, based on the result in the lookahead memory indicating the second set of data is not stored in the buffer, request the second set of data from the memory. In such embodiments, the linear access circuitry checks the lookahead memory before the lookahead circuitry modifies the lookahead memory based on the linear access request. In other words, the lookahead memory stores the result for the current linear access request, so the lookahead memory is checked before the lookahead circuitry looks ahead based on the current linear access request to the next potential linear access request. In some embodiments, the linear access circuitry is further configured to stall the initiator to wait for the memory to return the second set of data when it is not stored in the buffer. In some embodiments, the access circuitry is further configured to, in response to the buffer check circuitry determining the data is not stored in the buffer, stall the initiator to wait for the memory to return the data. In some embodiments, the memory read interface may further include prefetch circuitry, which may include a prefetch buffer. The prefetch circuitry may be configured to receive the request from the initiator and provide the request to the cache circuitry based on a determination that the data associated with the request is not stored in the prefetch buffer. In some embodiments, the prefetch circuitry is further configured to generate and issue linear access requests to the cache circuitry. In some embodiments, the buffer check circuitry is configured to determine whether the data is stored in the buffer based on a comparison of the memory address associated with the request and a set of memory addresses (e.g., tags) associated with the buffer. In some embodiments, the memory is non-volatile memory, such as flash memory.

One general aspect includes a system having an initiator (e.g., a central processing unit) configured to provide a first request for first data stored in a memory and a second request for second data stored in the memory contiguous with the first data. The system may further include a memory read interface coupled to the initiator and which may include cache circuitry. The cache circuitry may include a buffer, buffer check circuitry, lookahead circuitry, and access circuitry. The buffer check circuitry may be configured to determine, in response to the first request, whether the first data is stored in the buffer based on a first memory address associated with the first request. The lookahead circuitry may include a lookahead memory, and the lookahead circuitry may be configured to, in response to the first request, identify a second memory address associated with the second request based on the first memory address associated with the first request, use the buffer check circuitry for a lookahead determination to determine whether the second data stored at the second memory address is stored in the buffer, and store a result of the lookahead determination in the lookahead memory. The access circuitry may be configured to, in response to the second request, provide the second data to the initiator from the buffer when the lookahead memory indicates the second data is stored in the buffer, and request the second data from the memory when the lookahead memory indicates the second data is not stored in the buffer.

Implementations may include one or more of the following features. In some embodiments, the first request is a discontinuous access request and the access circuitry is further configured to, in response to the discontinuous access request, request the first data from the memory. While waiting for a response from the memory, the access circuitry is further configured to use the buffer check circuitry to determine whether the first data is in the buffer. In response to the buffer check circuitry determining the first data is stored in the buffer, the access circuitry is configured to provide the first data from the buffer and discard the first data returned from the memory. In response to the buffer check circuitry determining the first data is not stored in the buffer, the access circuitry is configured to provide the first data from the memory and store the first data in the buffer. In some embodiments, the access circuitry is further configured to, in response to the discontinuous access request, stall the initiator to wait for the memory to return the first data when the first data is not stored in the buffer. In some embodiments, the access circuitry is further configured to, in response to the second request, stall the initiator to wait for the memory to return the second data when the lookahead memory indicates the second data is not stored in the buffer. In some embodiments, the memory read interface may further include prefetch circuitry, which may include a prefetch buffer. The prefetch circuitry may be configured to receive the first request from the initiator and pass the first request to the cache circuitry based on a determination that the first data is not stored in the prefetch buffer. In some embodiments, the first data is a first instruction, the second data is a second instruction, and the buffer is a code cache buffer. In some embodiments, the buffer check circuitry is configured to determine whether the first data is stored in the buffer based on a comparison of a memory address associated with the first request and a set of memory addresses (e.g., tags) associated with the buffer. In some embodiments, the memory is non-volatile memory, such as flash memory.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system implementing a code cache, according to embodiments of the present invention.

FIG. 2 illustrates further details of the code cache, according to embodiments of the present invention.

FIG. 3 illustrates a flow chart of a process for servicing a discontinuous request using a code cache, according to embodiments of the present invention.

FIG. 4 illustrates a flow chart of a process for servicing a linear access request using a code cache, according to embodiments of the present invention.

FIG. 5 illustrates a data flow of a discontinuous request to a code cache when the requested data is not in the code cache buffer, according to embodiments of the present invention.

FIG. 6 illustrates a data flow of a discontinuous request to a code cache when the requested data is in the code cache buffer, according to embodiments of the present invention.

FIG. 7 illustrates a data flow of a linear access request to a code cache using a lookahead bit when the requested data is not in the code cache buffer, according to embodiments of the present invention.

FIG. 8 illustrates a data flow of a linear access request to a code cache using a lookahead bit when the requested data is in the code cache buffer, according to embodiments of the present invention.

### DETAILED DESCRIPTION

As described above, timing closure in a system on a chip (SoC) is complex. The addition of a code cache architecture often aggravates the complexity, increasing the number of clock cycles it takes to return the data to the processor or other initiator. To alleviate the increased timing complexity, improved systems and methods are disclosed herein.

Memory is divided into locations, each with a unique address that allows data to be accessed directly. Each memory address points to a specific unit of data of any arbitrary size, e.g., a byte or sequence of bytes such as words (i.e., two bytes), double words (four bytes), and the like. The addresses can be thought of as contiguously arranged within a memory space of the memory. Accordingly, a first address can be incremented to get to the next address because data at address 1 is “next to” data at address 2. Further, data at address 3 is “next to” data at address 2, but not “next to” data at address 1. A given memory may have a physical address space that identifies the specific circuits that store a unit of data and any number of nested virtual address spaces that remap the address space of a lower-level virtual address space or the physical address space. While the storage circuitry for a given address may not physically be next to the storage area for the next address, one can move about the storage area in the memory by incrementing the address to find the corresponding data. When data is requested, the initiator (e.g., a processor core of a central processing unit (CPU), prefetch engine, other initiator) may indicate whether the request is discontinuous or linear with respect to another request. When a request is linear, it indicates that the request is for data that is at the next address from the previous request. In other words, for example, if a first request for data at address 1 is immediately followed by a second request for data at address 2, the second request is a linear access request. When a request is discontinuous, it indicates that the request is not linear. In the previous example, the first request may be a discontinuous request.

Given the discussion of memory storage above and in a system implementing a code cache architecture, two timing paths (e.g., paths of data) are discussed that may pose timing challenges that may limit performance. The first timing path is related to discontinuous requests from the processor. Note that discontinuous requests generally originate from the CPU, and the request indicates that it is a discontinuous request. The first timing path is indicated below:
Discontinuous request address from CPU->buffer check logic->request forwarded to memory arbitration logic->arbitration logic sends request to memory

As indicated above, the buffer check logic introduces a timing lag to requests that miss in a code cache buffer and are ultimately served from memory. When the code cache buffer does not have the data, several clock cycles are spent executing the buffer check logic. For example, the buffer check logic may check whether the code cache buffer has the requested data by comparing tag values of the locations in the buffer with the memory address in the request. However, it may take multiple clock cycles to determine that the request is a miss in the code cache buffer. Thus, the forwarding of the request to an entity capable of providing the requested code may be delayed.

The second timing path is related to linear access requests, which may originate from the CPU, the prefetch engine, or other initiators. The second timing path is indicated below:
Linear access request address from initiator->buffer check logic->request forwarded to memory arbitration logic->arbitration logic sends request to memory

Again, the buffer check logic introduces a timing lag to requests that miss in the code cache buffer and are ultimately served from memory. Even though the code cache buffer does not have the data, several clock cycles are spent by the buffer check logic.

To address these timing issues, circuitry and corresponding logic within the code cache can be configured to optimize these timing paths. For the first timing path related to discontinuous requests, the requests can be forwarded directly to the memory without first checking the code cache buffer with the buffer check logic. This removes the clock cycles needed by the buffer check logic from the timing path when the buffer does not have the data. While waiting for the response from the memory, the code cache circuitry can execute the buffer check logic to determine whether the requested data is stored in the buffer. If the data is in the buffer, the code cache can serve the data from the buffer before the response from the memory ever arrives and discard the response from the memory once it does arrive. If the data is not in the buffer, the code cache can wait for the memory to return the data, serve the data once received, and store the data in the buffer. More requests may be forwarded to the memory because requests that ultimately hit in the code cache buffer are forwarded to the memory regardless, but there may still be an improvement in performance because the requests that miss in the code cache buffer are forwarded to the memory sooner. In this way, the data is served from the code cache most efficiently regardless of whether the data is stored in the buffer or not.

For the second timing path related to linear access requests, the address of the linear access request is known on the previous request because the next address (i.e., lookahead address) can be determined by incrementing the address included in the previous request. Accordingly, when a first request is received, regardless of whether it is discontinuous or linear, the code cache can look ahead to the next address, check the buffer, and store the result in a lookahead bit (e.g., a flip flop). For example, consider that the code cache receives a first request for data at address 1. In response to the first request, the code cache can, concurrently with the check to determine whether address 1 is a hit in the code cache buffer, increment the address to address 2 and check the buffer using the buffer check logic to determine whether the data at address 2 is in the buffer. If it is, a “yes” result can be stored in the lookahead bit. If not, a “no” result can be stored in the lookahead bit. Should the code cache subsequently receive a second linear request for data at address 2, the code cache has already checked the buffer for this data, and the answer as to whether the data is in the buffer is stored in the lookahead bit. The lookahead bit can be checked quickly (e.g., much more quickly than executing the buffer check logic), and the code cache can handle the request expediently based on the lookahead bit. If the lookahead bit indicates the data is in the buffer, the code cache can serve the data from the buffer. If the lookahead bit indicates the data is not in the buffer, the code cache need not check the buffer and instead may immediately send the second request to retrieve the data from the memory without performing a full comparison of the address in the second request to the tag values. In the meantime, the code cache can look ahead to address 3, execute the buffer check logic to determine whether the data at address 3 is stored in the buffer, and update the lookahead bit with the result. In this way, if the next request is a linear request (also called a linear access request) the lookahead bit will be updated with the correct result. Accordingly, for linear access requests, the clock cycles needed to execute the buffer check logic do not slow down the code cache response since the lookahead bit is updated with the information for the incoming linear request before processing the incoming linear request.

The code cache architecture described herein provides improvements to technology by reducing the clock cycles consumed by the timing paths described above. It is noted that while occasionally there will be additional work performed when, for example, the code cache buffer has the data on a discontinuous request, so the data is unnecessarily retrieved from memory as well, the overall improvement is substantial because this scenario is rare compared to the improved timing paths described above (e.g., where the data for a discontinuous request is not stored in the buffer). In example implemented embodiments, the improvements reduced the number of fan-in points to the memory read clock from 119 to just 13, which simplifies the timing by reducing the timing delay on the memory bank request path by 400 picoseconds (at 200 Megahertz). Thus, interconnect timing was closed at 250 Megahertz at 65 nm node. While these improvements are exemplary, they illustrate the improved performance of the computing system (e.g., SoC) when the disclosed improvements are implemented. Accordingly, the disclosed improvements increase computational response time, improving the computing device itself, by reducing the overall number of clock cycles needed to perform computational tasks.

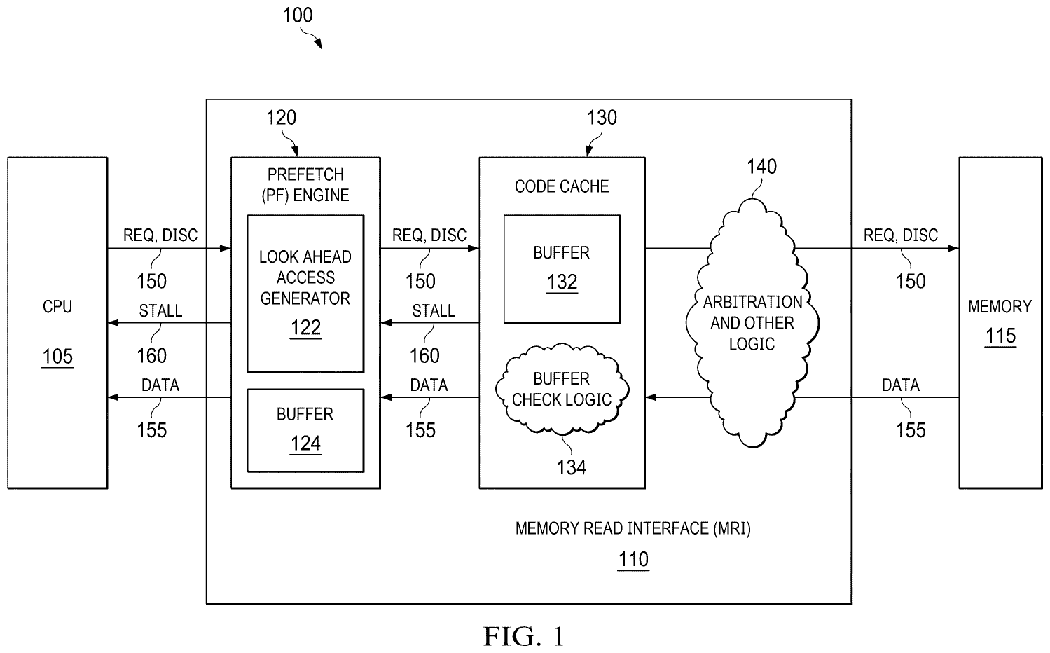

Turning now to the figures, FIG. 1 illustrates a system 100 that implements a code cache 130. System 100 may be, for example, a system on a chip (SoC) or any other computing system having a central processing unit (CPU) 105, memory read interface (MRI) 110, and memory 115. While system 100 depicts a CPU 105, MRI 110, and memory 115, system 100 may include other components or circuitry not shown here for clarity.

CPU 105 may be any suitable processing resource or initiator that may request data from memory 115. While described as a central processing unit, CPU 105 may not be the only request initiator, in some embodiments. For example, a co-processor having a capability of requesting and executing instructions may be the requestor. However, for ease of description, the initiator will be discussed as a processor, or CPU 105 throughout. In some embodiments, CPU 105 may be a microprocessor implemented in a SoC and may include any number of processing cores. CPU 105 may execute instructions (e.g., code) stored in memory 115. For example, in some embodiments, CPU 105 may execute the code from memory 115, where the code is executable instructions that, when executed by CPU 105, perform a function. CPU 105 may request any data, including executable instructions from memory 115. CPU 105 transmits the requests to MRI 110, shown as request 150. The requests include an indicator (e.g., a 0 or 1) that indicates whether the request is discontinuous or linear. The request also includes the address in memory at which the requested data is located.

Memory 115 is any suitable memory that may be implemented to store instructions or other data at addresses within memory 115. In some embodiments, memory 115 may be volatile or non-volatile memory. For example, memory 115 may be flash memory in some embodiments. Memory 115 is divided into locations, each with a unique address that points to a specific unit of data such as a byte or sequence of bytes, such as words (i.e., two bytes), double words (i.e., four bytes), and the like. Memory 115 has an address space that is the total range of addresses that CPU 105 can manage. As discussed above, the addresses in memory 115 are contiguous, such that a linear request indicates that the request is for data stored at the next address in memory 115. In other words, a linear request for data at address 2 follows a request for data at address 1. An example address in hexadecimal for address 1 may be 0x00400000, and address 2 may be 0x00400001, which indicates the next unit of data after the unit of data stored in address 1.

As discussed above, CPU 105 may request data stored at an address in memory 115, and when memory 115 receives the request 150, memory 115 responds with the data 155 stored at the specified address. MRI 110 may include any number of buffers to buffer data stored in memory 115, of which two are shown. Accordingly, in the illustrated example, before request 150 reaches memory 115, MRI 110 processes request 150 to determine whether the requested data can be served from buffer 124 by the prefetch engine 120 or buffer 132 by the code cache 130 rather than memory 115 serving the requested data.

MRI 110 is a memory read interface responsible for handling all requests for data from memory 115 and delivering the data back to the requester (e.g., CPU 105) in a reliable and timely manner. MRI 110 includes prefetch engine 120, code cache 130, and arbitration and other logic 140. MRI 110 may include many other components, circuitry, and functionality not shown or described here for clarity. For example, MRI 110 may perform address validation for requests from CPU 105, which is not described here for the sake of simplicity and clarity.

Prefetch engine 120 is designed to predict which data CPU 105 will request soon and obtain that data before CPU 105 requests it. Prefetch engine 120 may use any type of logic or architecture to predict future data requests for reducing latency between CPU 105 and memory 115. As shown, prefetch engine 120 includes lookahead access generator 122 and buffer 124, though prefetch engine 120 may include additional circuitry, components, and functionality for performing advanced prediction and minimizing latency in responding to requests 150 from CPU 105. Lookahead access generator 122 may predict which data may be requested soon and initiate requests (e.g., additional requests 150), which may be linear requests, to code cache 130. Upon receiving the requested data 155, prefetch engine 120 may store that requested data in buffer 124. In scenarios when prefetch engine 120 receives a request 150 from CPU 105, prefetch engine 120 may check its buffer 124 for the requested data. If prefetch engine 120 has the requested data in buffer 124, prefetch engine 120 serves the data from buffer 124. If prefetch engine 120 does not have the requested data in buffer 124, prefetch engine 120 forwards the request 150 to code cache 130. In other words, prefetch engine 120 issues requests 150 to code cache 130 and forwards requests 150 from CPU 105 to code cache 130, as needed. For example, prefetch engine 120 may forward discontinuous (non-linear) requests 150 from CPU 105 directly to code cache 130 without checking buffer 124 based on the assumption that prefetch engine 120 will not have the requested instruction in buffer 124. In contrast, for linear requests, buffer 124 may include the requested data, so the example prefetch engine 120 checks buffer 124, and if buffer 124 does not have the requested instruction, upon determining the requested data is not in buffer 124, prefetch engine 120 forwards the linear request 150 to code cache 130.

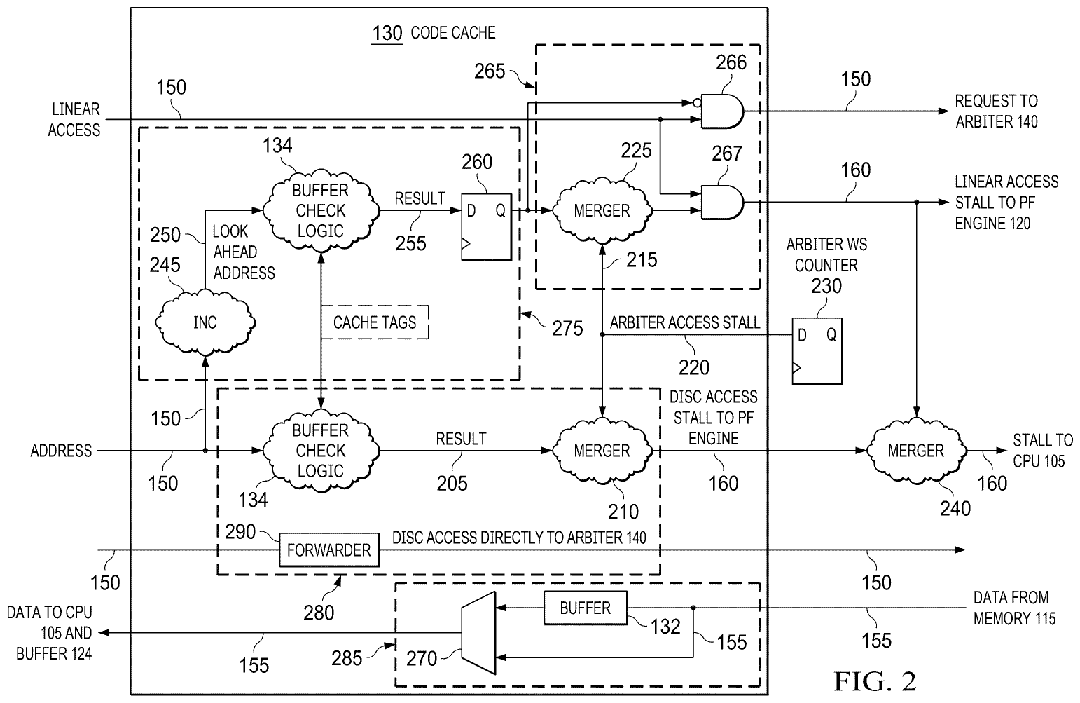

Code cache 130 may be specialized cache circuitry including a buffer 132 dedicated to storing program instructions (i.e., executable instructions) to improve the performance of CPU 105, whereas buffer 124 of prefetch engine 120 may store instructions as well as other types of data. For example, in scenarios in which CPU 105 executes code from memory 115, code cache 130 may improve latency. Code cache 130 includes buffer 132 and buffer check logic 134. Buffer check logic 134 may be implemented in circuitry and is used to determine when a request 150 for data stored at an address in memory 115 is stored in buffer 132. Buffer check logic 134 may compare the address included in request 150 with tags in buffer 132 associated with the data stored in buffer 132. The tags may include metadata such as the associated memory address of the data as stored in memory 115. The comparison of the tags with the requested address allows buffer check logic 134 to determine whether buffer 132 contains the requested data. If code cache 130 has the requested data stored in buffer 132, code cache 130 serves the requested data 155 from buffer 132. If not, code cache 130 forwards request 150 to arbitration and other logic 140 for retrieving the requested data 155 from memory 115. In some embodiments, code cache 130 forwards request 150 to arbitration and other logic 140 even when buffer 132 contains the requested data 155, as described in more detail herein. Additional details of code cache 130 are described in more detail with respect to FIG. 2. As is shown and described clearly with respect to FIG. 2, code cache 130 optimizes execution of buffer check logic 134 by avoiding introducing latency in at least the two timing paths described above. More specifically, when code cache 130 receives a discontinuous request, code cache 130 forwards the request 150 to arbitration and other logic 140 immediately, and while waiting for the resulting data 155 from memory 115, code cache 130 executes buffer check logic 134. If buffer 132 is storing data 155, code cache 130 serves data 155 from buffer 132 and discards the response of data 155 from memory 115. In contrast, when code cache 130 receives a linear access request, the work for linear access requests begins at the prior request. For example, when code cache 130 receives any request (i.e., linear access request or discontinuous access request), code cache 130 processes that request and performs a lookahead function. More specifically, code cache 130 increments the address included in the current request to obtain the next address, which will be the address included in the next request if the next request is a linear access request. Code cache 130 executes buffer check logic 134 to check buffer 132 for the data associated with the next address and stores the result (yes or no) in a lookahead bit (e.g., a flip flop). When code cache 130 receives the next request, if it is a linear access request, code cache 130 need not spend clock cycles executing buffer check logic 134 because the lookahead bit has the answer as to whether the requested data is in buffer 132. For example, it may take one or more clock cycles for code cache 130 to execute buffer check logic 134 depending on the size of buffer 132. Accordingly, executing buffer check logic 134 when code cache 130 may otherwise be idle and prior to receiving the request for the next address allows code cache 130 to not aggravate the timing closure by adding the additional clock cycle(s) to the time it takes to respond to the request for the next address. In other words, this allows code cache 130 to quickly serve the requested data from buffer 132 if the lookahead bit indicates the requested data is in buffer 132, and if not, forward request 150 to arbitration and other logic 140 to get data 155 from memory 115.

Arbitration and other logic 140 represents logic within MRI 110 for performing functionality not described in detail herein, but which includes arbitration logic for queueing and forwarding requests 150 to memory 115. As will be discussed in more detail with respect to FIG. 2, stall signals from code cache 130 may trigger a wait state counter (arbiter wait state counter 230 depicted and described in FIG. 2) that ensures arbitration and other logic 140 waits appropriately for receiving requests 150 from code cache 130 and responding with data 155 from memory 115.

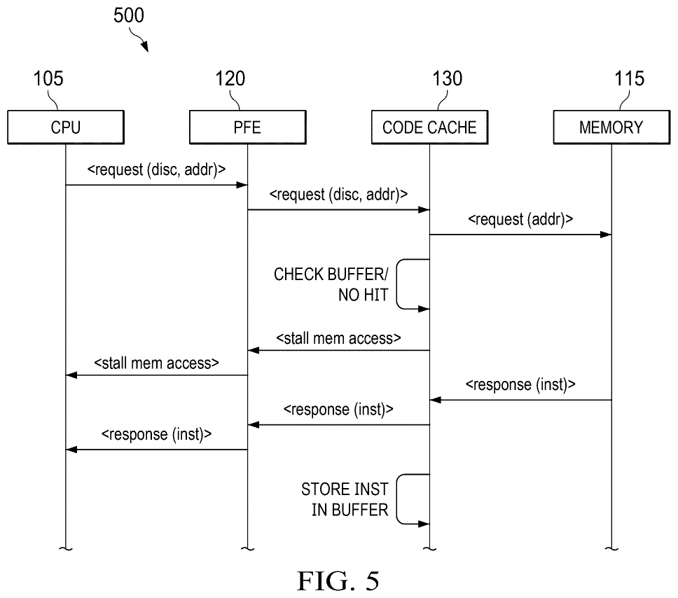

In use, several scenarios may occur, some of which are described with respect to data flow diagrams 500-800 of FIG. 5-8.

Scenario 1: Buffer 124 contains requested data 155. CPU 105 transmits request 150 (e.g., a linear access request or a discontinuous address) to prefetch engine 120. Prefetch engine 120 checks buffer 124 and determines the requested data is in buffer 124. Prefetch engine 120 serves data 155 from buffer 124. Request 150 does not get forwarded to code cache 130.

Scenario 2: CPU 105 issues a discontinuous request, buffer 124 does not contain the requested data, but buffer 132 contains the requested data. CPU 105 issues the discontinuous request 150. Prefetch engine 120 determines buffer 124 does not contain the requested data and forwards request 150 to code cache 130. Code cache 130 transmits request 150 to arbitration and other logic 140 AND executes buffer check logic 134. Code cache 130 determines buffer 132 has data 155. Code cache 130 issues a stall signal 160 to prefetch engine 120 for an appropriate wait time to serve data 155 from buffer 132. Prefetch engine 120 issues stall signal 160 to CPU 105. Code cache 130 serves data 155 from buffer 132 and discards the responsive data 155 from memory 115 when code cache 130 receives it. Once received, prefetch engine 120 serves data 155 to CPU 105.

Scenario 3: CPU 105 issues a discontinuous request, buffer 124 does not contain the requested data, and buffer 132 does not contain the requested data. CPU 105 issues the discontinuous request 150. Prefetch engine 120 determines buffer 124 does not contain the requested data and forwards request 150 to code cache 130. Code cache 130 transmits request 150 to arbitration and other logic 140 AND executes buffer check logic 134. Code cache 130 determines buffer 132 does not contain data 155. Code cache 130 issues a stall signal 160 to prefetch engine 120 for an appropriate wait time to serve data 155 from memory 115. Prefetch engine 120 issues stall signal 160 to CPU 105. Code cache 130 receives data 155 from memory 115 via arbitration and other logic 140 and serves it to prefetch engine 120. Code cache 130 may also store data 155 in buffer 132. Prefetch engine 120 serves data 155 to CPU 105 once received.

Scenario 4: Code cache 130 performs a lookahead check. While code cache 130 is handling a request 150, which can be either linear access or discontinuous, code cache 130 also looks ahead to the next address by incrementing the address included in the current request 150 and executes buffer check logic 134 to determine if buffer 132 has the data associated with the next address. Code cache 130 stores the result (e.g., 1 for yes, 0 for no) in a lookahead bit, a flip flop, or the like.

Scenario 5: Following scenario 4, lookahead access generator 122 predicts the next request may be a linear access request for the data at the next address and preemptively issues the linear access request to code cache 130. Alternatively, CPU 105 issues the next request as the linear access request without prefetch engine 120 predicting it. Code cache 130 receives the linear access request 150 and checks the lookahead bit, which is substantially faster than executing buffer check logic 134.

If the lookahead bit indicates buffer 132 includes the requested data, code cache 130 issues a stall signal 160 for an appropriate wait time to serve data 155 from buffer 132. Prefetch engine 120 receives stall signal 160 and sends it to CPU 105 if CPU 105 issued linear access request 150. Then code cache 130 serves data 155 from buffer 132. Once prefetch engine 120 receives data 155, lookahead access generator 122 saves data 155 to buffer 124 if prefetch engine 120 issued linear access request 150. If prefetch engine 120 did not issue linear access request 150, prefetch engine 120 serves data 155 to CPU 105.

If the lookahead bit indicates buffer 132 does not include the requested data, code cache 130 issues a stall signal 160 for an appropriate wait time to serve data 155 from memory 115, and code cache 130 forwards the linear access request 150 to arbitration and other logic 140 for retrieving data 155 from memory 115. Prefetch engine 120 receives stall signal 160 and, if CPU 105 issued linear access request 150, prefetch engine 120 issues stall signal 160 to CPU 105. When code cache 130 receives data 155 from memory 115 via arbitration and other logic 140, code cache 130 provides data 155 to prefetch engine 120. Prefetch engine 120 sends data 155 to CPU 105 if CPU 105 requested it. However, if lookahead access generator 122 initiated the linear access request, lookahead access generator 122 stores data 155 in buffer 124 in anticipation of CPU 105 requesting it.

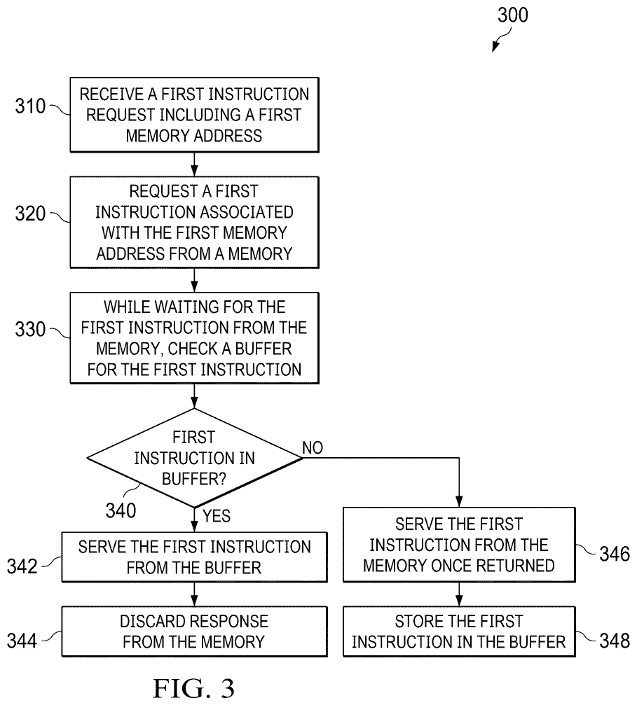

Additional data flows and corresponding processes of system 100 are further depicted and described with respect to FIG. 3-8.

FIG. 2 illustrates further details of code cache 130 according to some examples. Code cache 130 illustrates data flow and functionality, with various portions being implemented by circuitry within code cache 130. Circuitry may be configured in various different ways to generate the functionality described.

Code cache 130 includes buffer check logic 134 and buffer 132, which are described in detail with respect to FIG. 1. Code cache 130 further includes discontinuous request circuitry 280, linear access request circuitry 265, lookahead circuitry 275, and serving circuitry 285. Each of circuitries 265, 275, 280, and 285 are shown as dashed boxes to indicate which portions of the described functionality and depicted components are implemented using that respective circuitry. While indicated with dashed boxes, other configurations of the circuitry may be used or incorporated together when appropriate for handling the same functionality described.

Discontinuous request circuitry 280 utilizes the address included in request 150, buffer check logic 134 (e.g., which may be implemented in separate buffer check circuitry), merger logic 210, and forwarding component 290. When a discontinuous request 150 is received, forwarding component 290 forwards discontinuous request 150 directly to memory 115 via an arbiter (i.e., arbitration and other logic 140). Additionally, discontinuous request circuitry 280 uses buffer check logic 134 to check buffer 132 for the requested data. As described above, one option for buffer check logic 134 to function is for buffer check logic 134 to compare the address of request 150 with cache tags in buffer 132. The cache tags may be, for example, metadata associated with data saved in buffer 132. The metadata (i.e., cache tags) may include the memory address at which the associated data is stored in memory 115. Buffer check logic 135 generates result 205 which indicates whether buffer 132 has the requested data from request 150. Merger 210 may include logic that generates stall signal 160 to issue to prefetch engine 120. For example, if result 205 indicates data 155 is in buffer 132, merger 210 generates stall signal 160 to account for serving data 155 from buffer 132. If result 205 indicates data 155 is not in buffer 132, merger 210 generates stall signal 160 to account for serving data 155 from memory 115. Additionally, merger logic 210 incorporates any stall signals 220 issued by arbitration and other logic 140 via arbiter wait state counter 230. Arbiter wait state counter 230 may issue stall signals 220 to code cache 130 if arbiter and other logic 140 is busy. Accordingly, merger logic 210 generates appropriate stall signals based on stall signals 220 and whether buffer 132 includes data 155 to serve more quickly. Merger logic 210 may issue stall signal 160 to prefetch engine 120. Prefetch engine 120 may include merger logic 240 for handling stall signals 160 from discontinuous request circuitry 280 and linear access request circuitry 265 and forwarding them, as needed, to CPU 105. Serving circuitry 285 is used to serve data 155 once discontinuous request circuitry 280 determines whether buffer 132 contains data 155 to serve or if code cache 130 needs to wait for data 155 from memory 115 to serve. The circuitry connecting discontinuous request circuitry 280 to serving circuitry 285 is not shown for simplicity.

Whether the request is a discontinuous request or a linear access request, lookahead circuitry 275 checks the buffer for data associated with the next address, just in case the next request is a linear access request. Lookahead circuitry 275 includes increment logic 245 and flip flop 260 (i.e., lookahead bit). Lookahead circuitry 275 uses buffer check logic 134 to perform the check. When a request 150 arrives, lookahead circuitry 275 receives the address from request 150 and uses increment logic 245 to increment the address and generate the lookahead address 250 (i.e., the “next” address). As discussed above, depending on how memory 115 stores data, the lookahead address 250 may be generated by increment logic 245 by increasing the address in request 150 to request the next sequential unit of data. For example, if memory 115 stores data and uses a byte-by-byte addressing system, increment logic 245 increases the address by one byte. If, for example, memory 115 stores data and uses a word-by-word addressing system, increment logic 245 increases the address by one word (i.e., two bytes). Lookahead circuitry 275 uses buffer check logic 134 to check buffer 132 for the data associated with lookahead address 250. Buffer check logic 134 issues result 255 (e.g., 1 for data is in buffer 132, 0 for data is not in buffer 132), and lookahead circuitry 275 stores the result in flip flop 260, although any bit or binary storage device may be used.

Linear access request circuitry 265 includes AND gate 266, AND gate 267, and merger logic 225. Lookahead circuitry 275 has already saved the result of buffer check logic 134 for the current linear access request 150 (i.e., during the last request that came in) when linear access request circuitry 254 receives the linear access requests 150. Linear access request circuitry 265 uses AND gate 266 to check flip flop 260 to determine if buffer 132 includes the requested data. If not, AND gate 266 issues the linear access request 150 to arbitration and other logic 140. If so, serving circuitry 285 serves data 155 from buffer 132. The circuitry sending the instruction to buffer 132 to serve the data is not shown for simplicity. Further, merger logic 225 checks flip flop 260 and determines whether stall signal 160 needs to indicate a stall sufficient to wait for serving from buffer 132 or from memory 115. Merger logic 225 may further account for any stall signals 220 from arbiter wait state counter 230 when generating stall signal 160, which is issued by AND gate 267. Meanwhile, after flip flop 260 is checked by linear access request circuitry 265, lookahead circuitry 275 checks the next address and updates flip flop 260.

Serving circuitry 285 includes buffer 132 and multiplexer 270. Data 155 is received from memory 115 (e.g., via arbitration and other logic 140) when requests 150 are issued to memory 115 for retrieving data 155. If buffer 132 includes the requested data as determined by discontinuous request circuitry 280 or linear access request circuitry 265, multiplexer 270 serves data 155 from buffer 132. On discontinuous access requests 150 when buffer 132 includes data 155, data 155 received from memory 115 is discarded. For requests 150 when buffer 132 does not include data 155, data 155 is stored in buffer 132 and multiplexer 270 serves data 155 from memory 115. Serving circuitry 285 may receive signals from discontinuous request circuitry 280 and linear access request circuitry 265 though connecting circuitry is not shown for simplicity.

FIG. 3-8 provide additional processes and data flows using the components of code cache 130 described above.

FIG. 3 illustrates a flow chart of a process 300 for servicing a discontinuous request (e.g., request 150) using a code cache (e.g., code cache 130) according to some examples.

Process 300 may be performed by system 100 and particularly by code cache 130. At step 310, the code cache (e.g., code cache 130) may receive a first instruction request including a first memory address. The first instruction request may be a discontinuous access request. For example, an initiator such as a processor core (e.g., a processor core of CPU 105) may issue discontinuous access request 150 to MRI 110. Prefetch engine 120 may determine it does not have the requested data and forward request 150 to code cache 130.

At step 320, the code cache may request a first instruction associated with the first memory address from a memory, which may be performed before, during, or after checking an associated buffer 132 for the first instruction in step 330. For example, forwarding component 290 in discontinuous request circuitry 280 may forward request 150 to memory 115 via arbitration and other logic 140. Request 150 may include the address at which memory 115 stores the requested data 155.

At step 330, the code cache may check a buffer for the first instruction. For example, while waiting for data 155 from memory 115 via arbitration and other logic 140, discontinuous request circuitry 280 in code cache 130 may execute buffer check logic 134 to determine if buffer 132 has the requested data 155. Buffer check logic 134 may compare the address in request 150 with cache tags (e.g., metadata associated with data stored in buffer 132) to determine if buffer 132 has the data associated with the address in request 150.

At step 340, the code cache determines whether the first instruction is in the buffer. For example, code cache 130 determines whether buffer 132 includes the requested data 155 based on result 205 from buffer check logic 134.

At step 342, if the code cache determines the first instruction is in the buffer, the code cache serves the first instruction from the buffer. For example, if code cache 130 determines the requested data 155 is in buffer 132 based on result 205, code cache 130 uses serving circuitry 285 to serve data 155 from buffer 132.

At step 344, after serving the first instruction from the buffer, the code cache discards the response from the memory. For example, after serving circuitry 285 serves data 155 from buffer 132, serving circuitry 285 will receive data 155 from memory 115 because forwarding component 290 forwarded request 150 directly to arbitration and other logic 140 to retrieve data 155 from memory 115. When serving circuitry 285 receives data 155 from memory 115, serving circuitry 285 will discard the response.

At step 346, which happens instead of step 342 because the code cache determined the first instruction was not in the buffer, the code cache serves the first instruction from the memory once returned. For example, when code cache 130 determines data 155 is not in buffer 132 based on result 205, serving circuitry 285 receives data 155 from memory 115 via arbitration and other logic 140 because forwarding component 290 forwarded request 150 directly to arbitration and other logic 140 to retrieve data 155 from memory 115. When serving circuitry 285 receives data 155, multiplexer 270 serves data 155 to prefetch engine 120, which sends data 155 to CPU 105.

At step 348, after receiving the first instruction from the memory, the code cache may store the first instruction in the buffer. For example, serving circuitry 285 may store data 155 in buffer 132 after receiving data 155 from memory 115.

Accordingly, when buffer 132 does not include the requested data for a discontinuous access request (the first timing path), code cache 130 serves data 155 from memory 115 without adding clock cycles for checking buffer 132 with buffer check logic 134. Additionally, when buffer 132 does include the requested data for a discontinuous access request, code cache 130 serves data 155 from memory 115 immediately after executing buffer check logic 134.

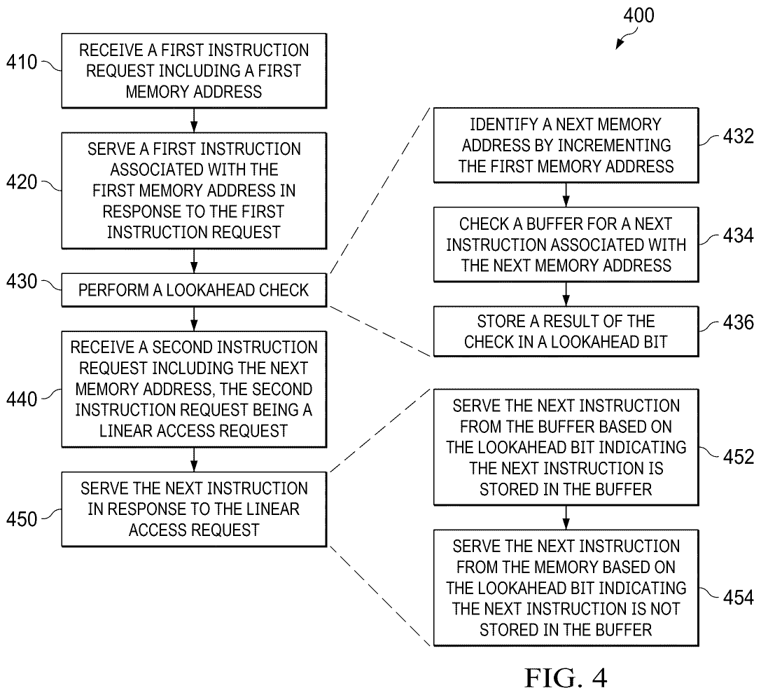

FIG. 4 illustrates a flow chart of a process 400 for servicing a linear access request (e.g., request 150) using a code cache (e.g., code cache 130) in some examples. Process 400 may be performed by system 100 and particularly by code cache 130. At step 410, the code cache (e.g., code cache 130) may receive a first instruction request including a first memory address. The first instruction request may be a discontinuous access request or a linear access request. For example, an initiator such as a processor core (e.g., a processor core of CPU 105) may issue a discontinuous access request or a linear access request (request 150) to MRI 110. Prefetch engine 120 may determine it does not have the requested data and forward request 150 to code cache 130. In some embodiments, prefetch engine 120 may predict a linear access request will be issued next and issue a linear access request 150 to code cache 130.

At step 420, the code cache serves a first instruction associated with the first instruction request in response to receiving the first instruction request. For example, code cache 130 may serve data 155 in response to request 150. In some embodiments, code cache 130 may serve data 155 from buffer 132 if buffer 132 includes data 155. If buffer 132 does not include data 155, code cache 130 transmits request 150 to arbitration and other logic 140 to retrieve data 155 from memory 115. If the first request is a discontinuous request, discontinuous request circuitry 280 handles the first instruction request. If the first request is a linear access request, linear access request circuitry 265 handles the first instruction request. In either case, code cache 130 serves data 155 to prefetch engine 120.

At step 430, the code cache performs a lookahead check. Step 430 may be performed in tandem with step 420. In other words, step 430 need not be completed before step 430 is started or completed. To perform the lookahead check, code cache 130 may use lookahead circuitry 275 to increment the first memory address. The first instruction request includes the first memory address, so the next memory address is identified by incrementing the first instruction request (step 432). Lookahead circuitry 275 uses buffer check logic 134 to check buffer 132 for the next instruction associated with the next memory address (step 434). Lookahead circuitry 275 stores result 255 in a lookahead bit (i.e., flip flop 260) (step 436).

At step 440, the code cache receives a second instruction request including the next memory address, where the second instruction request is linear access request. For example, code cache 130 receives a linear access request 150 from prefetch engine 120 either issued from CPU 105 or from prefetch engine 120.

At step 450, the code cache serves the next instruction in response to the linear access request (i.e., the second instruction request). Code cache 130 uses linear access request circuitry 265 to check the lookahead bit (i.e., flip flop 260) and serves the next instruction based on the lookahead bit. If the lookahead bit indicates the next instruction is in buffer 132, code cache 130 serves data 155 (i.e., the next instruction) from buffer 132 (step 452). If the lookahead bit indicates the next instruction is not in buffer 132, code cache 130 serves data 155 from memory 115 (step 454). For example, if flip flop 260 indicates the requested data is not in buffer 132, linear access request circuitry 265 sends the second instruction request (request 150) to memory 115 via arbitration and other logic 140. Once memory 115 provides data 155 to code cache 130, serving circuitry 285 serves data 155 to prefetch engine 120.

Accordingly, when code cache 130 receives a linear access request (the second timing path), code cache 130 serves the requested data expediently without spending clock cycles on executing buffer check logic 134 because it was executed in anticipation of receiving the linear access request. Buffer check logic 134 takes many clock cycles to execute, but checking a lookahead bit is fast in comparison. Using the described circuitry and logic, whether buffer 132 includes the requested data or not, code cache 130 can return data 155 to prefetch engine 120 in response to receiving linear access requests without first executing buffer check logic 134.

In contrast, when the second instruction received at step 440 is discontinuous as opposed to linear, the associated instruction may be retrieved as described in the steps of FIG. 3.

FIG. 5 illustrates a data flow 500 depicting communications and functions performed for a discontinuous request handled by code cache 130 when the requested data is not in buffer 132 (i.e., the first timing path). This is also described as Scenario 3 with respect to FIG. 1. For the purposes of data flow 500, time moves vertically down the drawing. In other words, the further down the figure, the later in time the communication occurs. In data flow 500, CPU 105 issues a discontinuous request (request 150) to prefetch engine 120. Prefetch engine 120 may check and determine its buffer (i.e., buffer 124) does not include the requested data (i.e., data 155). Therefore, prefetch engine 120 forwards request 150 to code cache 130. Forwarding component 290 of discontinuous request circuitry 280 in code cache 130 immediately forwards request 150 to memory 115 via arbitration and other logic 140.

In the meantime, discontinuous request circuitry 280 uses buffer check logic 134 to check buffer 132 and determines buffer 132 does not include the requested data (no hit). Code cache 130 generates and issues stall instruction 160 to prefetch engine 120 sufficient to ensure prefetch engine 120 and CPU 105 wait long enough for code cache 130 to serve data 155 from memory 115. Prefetch engine 120 sends stall instruction 160 to CPU 105. Memory 115 responds with the requested instruction (i.e., data 155) to code cache 130. Serving circuitry 285 in code cache 130 serves the response to prefetch engine 120, and prefetch engine 120 sends the response to CPU 105. Code cache 130 may also store the instruction in the response (i.e., data 155) in buffer 132.

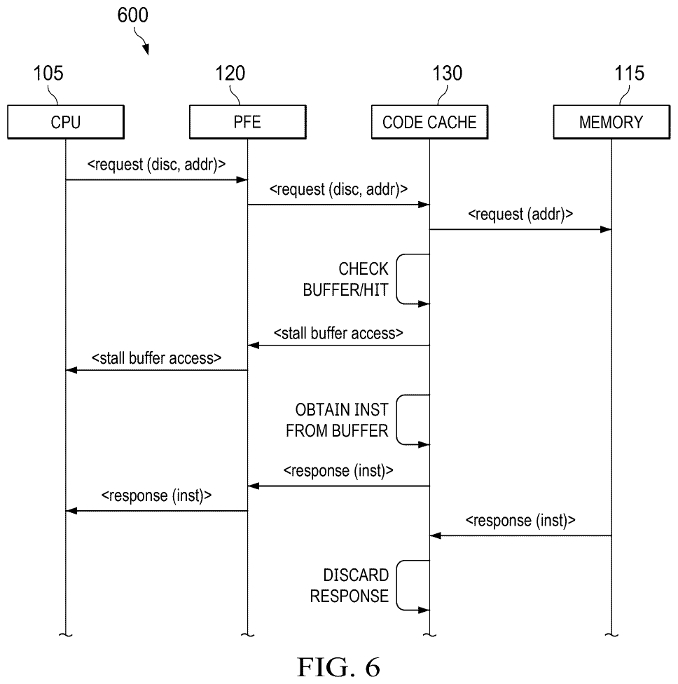

FIG. 6 illustrates a data flow 600 depicting communications and functions performed for a discontinuous request handled by code cache 130 when the requested data is in buffer 132. This is also described as Scenario 2 with respect to FIG. 1. For the purposes of data flow 600, time moves vertically down the drawing. In other words, the further down the figure, the later in time the communication occurs. In data flow 600, CPU 105 issues a discontinuous request (request 150) to prefetch engine 120. Prefetch engine 120 may check and determine its buffer (i.e., buffer 124) does not include the requested data (i.e., data 155). Therefore, prefetch engine 120 forwards request 150 to code cache 130. Forwarding component 290 of discontinuous request circuitry 280 in code cache 130 immediately forwards request 150 to memory 115 via arbitration and other logic 140.

In the meantime, discontinuous request circuitry 280 uses buffer check logic 134 to check buffer 132 and determines buffer 132 include the requested data (hit). Code cache 130 generates and issues stall instruction 160 to prefetch engine 120 sufficient to ensure prefetch engine 120 and CPU 105 wait long enough for code cache 130 to serve data 155 from buffer 132. Prefetch engine 120 sends the stall instruction 160 to CPU 105. Serving circuitry 285 in code cache 130 serves the instruction (i.e., data 155) from buffer 132 by obtaining the data and sending it to prefetch engine 120. Prefetch engine 120 sends the response to CPU 105. Meanwhile, memory 115 responds with the requested instruction (i.e., data 155) to code cache 130. Code cache 130 discards the response from memory 115 since data 155 was already served in response to the request.

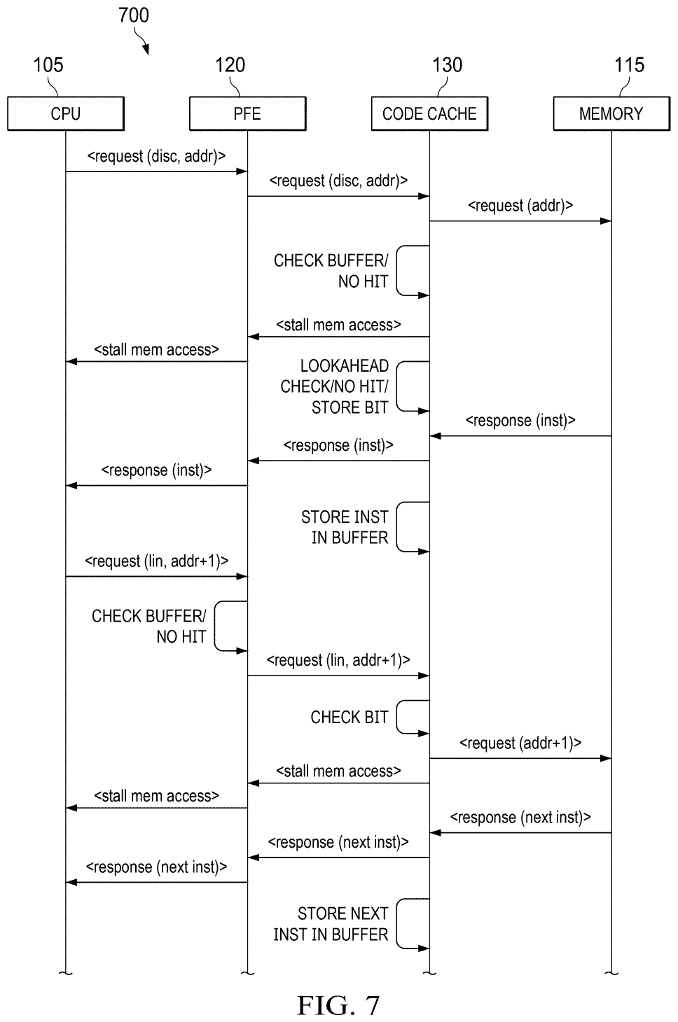

FIG. 7 illustrates a data flow 700 depicting communications and functions performed for a linear access request handled by code cache 130 using a lookahead bit (i.e., flip flop 260) when the requested data is not in buffer 132 (i.e., the second timing path). This is also described in Scenarios 4 and 5 with respect to FIG. 1. For the purposes of data flow 700, time moves vertically down the drawing. In other words, the further down the figure, the later in time the communication occurs. In data flow 700, CPU 105 issues a discontinuous request (request 150) to prefetch engine 120. Prefetch engine 120 may check and determine its buffer (i.e., buffer 124) does not include the requested data (i.e., data 155). Therefore, prefetch engine 120 forwards request 150 to code cache 130. Forwarding component 290 of discontinuous request circuitry 280 in code cache 130 immediately forwards request 150 to memory 115 via arbitration and other logic 140.

In the meantime, discontinuous request circuitry 280 uses buffer check logic 134 to check buffer 132 and determines buffer 132 does not include the requested data (no hit). Code cache 130 generates and issues stall instruction 160 to prefetch engine 120 sufficient to ensure prefetch engine 120 and CPU 105 wait long enough for code cache 130 to serve data 155 from memory 115. Prefetch engine 120 sends stall instruction 160 to CPU 105.

Immediately after issuing the stall instruction, code cache 130 uses lookahead circuitry 275 to increment the address of the current request to identify the next address. Then lookahead circuitry 275 uses buffer check logic 134 to check buffer 132 for the next instruction, which is associated with the next address. In this example, buffer check logic 134 determines buffer 132 does not include the next instruction (i.e., no hit). Lookahead circuitry 275 stores result 255 (no hit) in flip flop 260.

Memory 115 responds with the requested instruction (i.e., data 155) to code cache 130. Serving circuitry 285 in code cache 130 serves the response to prefetch engine 120, and prefetch engine 120 sends the response to CPU 105. Code cache 130 may also store the instruction in the response (i.e., data 155) in buffer 132.

CPU 105 receives the response and issues a linear request to prefetch engine 120. For example, CPU 105 may be executing code from memory 115, and the next instruction for execution is at the next memory address. Prefetch engine checks buffer 124 and determines the requested instruction is not in buffer 124. Prefetch engine 120 sends the linear access request to code cache 130. Linear access request circuitry 265 checks flip flop 260 using AND gate 266 to find that flip flop 260 is storing a no-hit result. Linear access request circuitry 265 issues the linear access request to memory 115 via arbitration and other logic 140. Linear access request circuitry 265 further issues a stall instruction 160 to prefetch engine sufficiently long to allow code cache 130 to serve data 155 from memory 115. Prefetch engine 120 sends stall instruction 160 to CPU 105. In the meantime, memory 115 responds to code cache 130 with a response to the linear access request, which includes the next instruction. Serving circuitry 285 serves the response to the linear access request to prefetch engine 120. Prefetch engine 120 serves the response to CPU 105. Further, code cache 130 may store the next instruction from the response to the linear access request in buffer 132.

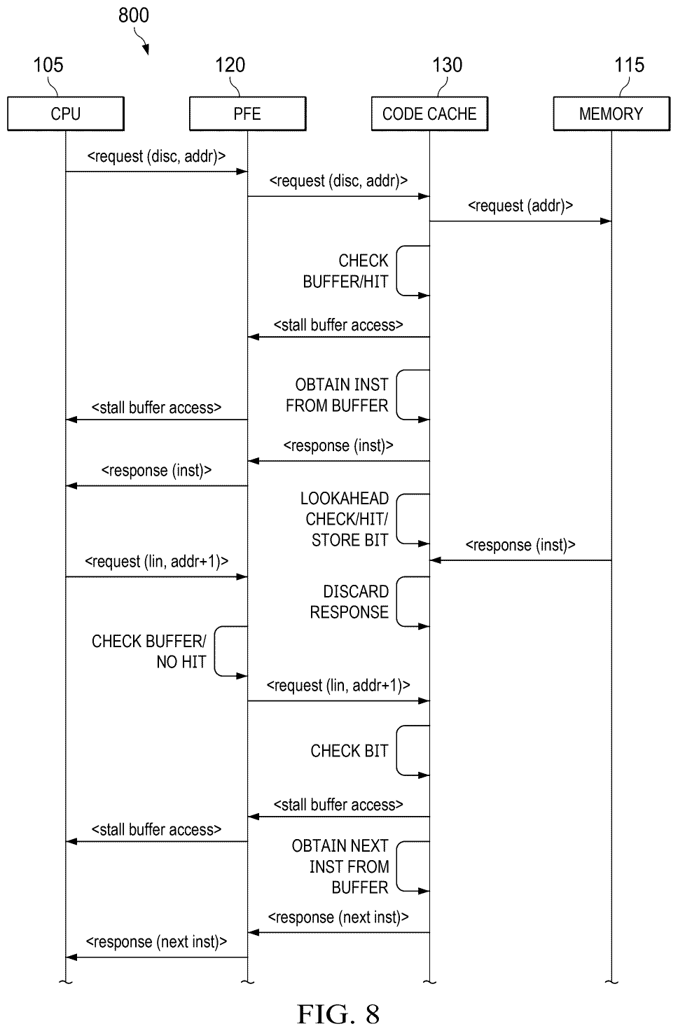

FIG. 8 illustrates a data flow 800 depicting communications and functions performed for a linear access request handled by code cache 130 using a lookahead bit (i.e., flip flop 260) when the requested data is in buffer 132. This is also described in Scenarios 4 and 5 with respect to FIG. 1. For the purposes of data flow 800, time moves vertically down the drawing. In other words, the further down the figure, the later in time the communication occurs. In data flow 800, CPU 105 issues a discontinuous request (request 150) to prefetch engine 120. Prefetch engine 120 may check and determine its buffer (i.e., buffer 124) does not include the requested data (i.e., data 155). Therefore, prefetch engine 120 forwards request 150 to code cache 130. Forwarding component 290 of discontinuous request circuitry 280 in code cache 130 immediately forwards request 150 to memory 115 via arbitration and other logic 140.

In the meantime, discontinuous request circuitry 280 uses buffer check logic 134 to check buffer 132 and determines buffer 132 includes the requested data (hit). Code cache 130 generates and issues stall instruction 160 to prefetch engine 120 sufficient to ensure prefetch engine 120 and CPU 105 wait long enough for code cache 130 to serve data 155 from buffer 132. Prefetch engine 120 sends stall instruction 160 to CPU 105.

Immediately after issuing the stall instruction, code cache 130 uses serving circuitry 285 to obtain the requested instruction (data 155) from buffer 132 and serve the response with the requested instruction to prefetch engine 120. Prefetch engine 120 serves the response to CPU 105.

Immediately after serving the response, code cache 130 uses lookahead circuitry 275 to increment the address of the current request to identify the next address. Then lookahead circuitry 275 uses buffer check logic 134 to check buffer 132 for the next instruction, which is associated with the next address. In this example, buffer check logic 134 determines buffer 132 includes the next instruction (i.e., hit). Lookahead circuitry 275 stores result 255 (hit) in flip flop 260.

Memory 115 responds with the requested instruction (i.e., data 155) to code cache 130. Serving circuitry 285 in code cache 130 discards the response.

CPU 105 receives the response and issues a linear request to prefetch engine 120. For example, CPU 105 may be executing code from memory 115, and the next instruction for execution is at the next memory address. Prefetch engine checks buffer 124 and determines the requested instruction is not in buffer 124. Prefetch engine 120 sends the linear access request to code cache 130. Linear access request circuitry 265 checks flip flop 260 using AND gate 266 to find that flip flop 260 is storing a hit result. Linear access request circuitry 265 issues a stall instruction 160 to prefetch engine sufficiently long to allow code cache 130 to serve data 155 from buffer 132. Prefetch engine 120 sends stall instruction 160 to CPU 105. In the meantime, serving circuitry 285 serves the response to the linear access request to prefetch engine 120 from buffer 132. Prefetch engine 120 serves the response to CPU 105. Note that this process may continue such that as soon as code cache 130 serves the response to prefetch engine 120, code cache 130 may use lookahead circuitry 275 again to check buffer 132 for the next address. Also note that using this technique, flip flop 260 will always maintain the correct result for any incoming linear access request.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system. ” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A system, comprising:
an initiator configured to provide a request for data stored in a memory; and
a memory read interface coupled to the initiator, wherein the memory read interface comprises cache circuitry, the cache circuitry comprising:
a buffer;
buffer check circuitry configured to determine whether the data associated with the request is stored in the buffer based on a memory address associated with the request; and
access circuitry configured to, concurrent with the buffer check circuitry determining whether the data is stored in the buffer, request the data from the memory;
wherein the memory read interface is configured to:
in response to the buffer check circuitry determining that the data is stored in the buffer:
provide the data from the buffer, and
discard a copy of the data returned from the memory; and
in response to the buffer check circuitry determining that the data is not stored in the buffer:
provide the data from the memory, and
store the data in the buffer.

2. The system of claim 1, wherein:
the data is a first set of data; and
the cache circuitry further comprises:
a lookahead memory; and
lookahead circuitry configured to:
identify a next memory address based on the memory address associated with the request;
use the buffer check circuitry for a lookahead determination to determine whether a second set of data stored at the next memory address is stored in the buffer; and
store a result of the lookahead determination in the lookahead memory.

3. The system of claim 2, wherein the cache circuitry further comprises:
linear access circuitry configured to, in response to a linear access request:
based on the result in the lookahead memory indicating the second set of data is stored in the buffer, provide the second set of data to the initiator from the buffer; and
based on the result in the lookahead memory indicating the second set of data is not stored in the buffer, request the second set of data from the memory.

4. The system of claim 3, wherein the linear access circuitry is further configured to, based on the result in the lookahead memory indicating the second set of data is not stored in the buffer, stall the initiator to wait for the memory to return the second set of data.

5. The system of claim 1, wherein the access circuitry is further configured to, in response to the buffer check circuitry determining the data is not stored in the buffer, stall the initiator to wait for the memory to return the data.

6. The system of claim 1, wherein the memory read interface further comprises:
prefetch circuitry comprising a prefetch buffer, the prefetch circuitry configured to:
receive the request from the initiator; and
provide the request to the cache circuitry based on a determination that the data associated with the request is not stored in the prefetch buffer.

7. The system of claim 1, wherein the data is an instruction and the buffer is a code cache buffer.

8. The system of claim 1, wherein the buffer check circuitry is configured to determine whether the data is stored in the buffer based on a comparison of the memory address associated with the request and a set of memory addresses associated with the buffer.

9. The system of claim 1, further comprising:
the memory, wherein the memory is non-volatile memory.

10. A system, comprising:
an initiator configured to provide a first request for first data stored in a memory and a second request for second data stored in the memory contiguous with the first data; and
a memory read interface coupled to the initiator, wherein the memory read interface comprises cache circuitry, the cache circuitry comprising:
a buffer;
buffer check circuitry configured to determine, in response to the first request, whether the first data associated with the first request is stored in the buffer based on a first memory address associated with the first request;
lookahead circuitry comprising a lookahead memory, the lookahead circuitry configured to in response to the first request:
identify a second memory address associated with the second request based on the first memory address associated with the first request,
use the buffer check circuitry for a lookahead determination to determine whether the second data stored at the second memory address is stored in the buffer, and
store a result of the lookahead determination in the lookahead memory;
access circuitry configured to, in response to the second request:
based on the result in the lookahead memory indicating that the second data is stored in the buffer, provide the second data to the initiator from the buffer; and
based on the result in the lookahead memory indicating that the second data is not stored in the buffer, request the second data from the memory.

11. The system of claim 10, wherein the first request is a discontinuous access request, and wherein the access circuitry is further configured to, in response to the discontinuous access request:
request the first data from the memory;
in response to the buffer check circuitry determining the first data is stored in the buffer:
provide the first data from the buffer; and
discard the first data returned from the memory, and
in response to the buffer check circuitry determining the first data is not stored in the buffer:
provide the first data from the memory; and
store the first data in the buffer.

12. The system of claim 11, wherein the access circuitry is further configured to, in response to the discontinuous access request:
in response to the buffer check circuitry determining the first data is not stored in the buffer, stall the initiator to wait for the memory to return the first data.

13. The system of claim 10, wherein the access circuitry is further configured to, in response to the second request:
based on the result in the lookahead memory indicating the second data is not stored in the buffer, stall the initiator to wait for the memory to return the second data.

14. The system of claim 10, wherein the memory read interface further comprises:
prefetch circuitry comprising a prefetch buffer, the prefetch circuitry configured to:
receive the first request from the initiator; and
pass the first request to the cache circuitry based on a determination that the first data is not stored in the prefetch buffer.

15. The system of claim 10, wherein the first data is a first instruction, the second data is a second instruction, and the buffer is a code cache buffer.

16. The system of claim 10, wherein the buffer check circuitry is configured to determine whether the first data is stored in the buffer based on a comparison of a memory address associated with the first request and a set of memory addresses associated with the buffer.

17. The system of claim 10, further comprising:
the memory, wherein the memory is non-volatile memory.

18. A method, comprising:
receiving, at a memory read interface of a memory, a first request comprising a first memory address;
providing, by a code cache of the memory read interface, first data associated with the first memory address in response to the first request;
performing, by the code cache, a lookahead check, wherein the lookahead check comprises:
identifying a next memory address based on incrementing the first memory address,
checking a buffer for second data associated with the next memory address, and
storing a result of the checking in a lookahead memory;
receiving, at the memory read interface, a second request comprising the next memory address; and
providing, by the code cache, the second data in response to the second request, wherein providing the second data comprises:
providing the second data from the buffer based on the lookahead memory indicating the second data is stored in the buffer, and
providing the second data from the memory based on the lookahead memory indicating the second data is not stored in the buffer.

19. The method of claim 18, wherein the providing the first data comprises:
requesting, by the code cache, the first data from the memory;
checking, by the code cache, the buffer for the first data based on the first memory address;
in response to determining the first data is stored in the buffer:
providing the first data from the buffer, and
discarding the first data received from the memory; and
in response to determining the first data is not stored in the buffer:
providing the first data upon receiving the first data from the memory, and
storing the first data in the buffer.

20. The method of claim 19, wherein:
providing the first data further comprises:
in response to determining the first data is not stored in the buffer, sending a stall instruction to an initiator to stall the initiator while the code cache waits for the first data from the memory; and
providing the second data further comprises:
in response to the lookahead memory indicating the second data is not stored in the buffer:
requesting the second data from the memory; and
sending a second stall instruction to the initiator to stall the initiator while the code cache waits for the second data from the memory.
